(19) United States
(12) Patent Application Publication
(10) Pub. No.: US 2026/0160317 A1
(43) Pub. Date: Jun. 11, 2026

(54) BALL DEFLECTOR OF A BALL SCREW DRIVE

(71) Applicant: SFS Group International AG, Heerbrugg (CH)

(72) Inventors: Jasmin HANSELMANN, Altstätten (CH); Daniel SINZ, Kennelbach (AT); Heribert GRABHERR, Wangen im Allgäu (DE); Marijo ZACH, Widnau (CH)

(73) Assignee: SFS Group International AG, Heerbrugg (CH)

(21) Appl. No.: 19/411,658

(22) Filed: Dec. 8, 2025

(30) Foreign Application Priority Data
Dec. 9, 2024 (EP) 24218505.6

(51) Int. Cl. F16H 25/22

(52) U.S. Cl. CPC F16H 25/2228

(57) ABSTRACT

A ball screw drive with a threaded spindle and a spindle nut surrounding the threaded spindle coaxially, and balls that circulate in a helical ball channel therebetween. A ball return system arranged in the threaded spindle, has two ball deflections with a deflection channel therebetween that is parallel to the center axis, for closed ball circulation. The balls follow a guide path from the ball channel into the deflection channel, which has at least one circular passage with a clear width L_{W} and two curved deflection sections. The second deflection section, located directly adjacent to the transition to the ball channel, is derived from a quarter circle basic shape. The transition from the ball deflection to the deflection channel is offset parallel to the end plane of the quarter circle by a distance d₁, and the passage Lw is extended in height by a distance d₂, where d₁≈d₂.

### CROSS-REFERENCE TO RELATED APPLICATIONS

This application claims priority from European Patent Application No. 24218505.6, filed Dec. 9, 2024, which is incorporated herein by reference as if fully set forth.

### TECHNICAL FIELD

The present invention relates to a ball screw drive for use in an electromechanical brake, specifically to the ball deflection from the circulation path between the threaded spindle and the spindle nut.

### BACKGROUND

A ball screw, also known as a ball screw drive (BSD), is usually defined as a rolling screw drive with balls as rolling elements. From a technical point of view, ball screw drives are screw drives in which the rotary motion of a drive machine is converted into a longitudinal motion.

The main components of a ball screw drive include a threaded spindle and a spindle nut that surrounds this spindle. Balls run between these two components during operation. The threaded sections of the threaded spindle and the spindle nut are designed as ball grooves with a suitable cross-section and are complementarily matched to each other so that together (when assembled) they form a helical ball channel consisting of two half-shells. Unlike a screw-nut connection, in which the thread flanks slide flat against each other, in the ball screw drive the balls circulating in the thread transfer the load between the nut and the spindle. The flat sliding movement is thus replaced by a rolling movement, which is accompanied by reduced friction.

A ball return system is used to maintain a closed circulation path for the balls. Its task is to lift the balls out of the ball channel between the spindle nut and the threaded spindle at a first point and feed them back in at a second point. The ball return system thus represents a bypass that bridges one or more threaded sections of the nut-spindle system, thereby forming a closed circulation path for the balls of a ball screw drive. A ball deflection directs the balls out of the ball channel and transfers them to a deflection channel. After passing through the deflection channel, the balls are returned to the ball channel via a second ball deflection. The ball return system therefore consists of two ball deflections and the deflection channel between them.

As a rule, the balls are guided radially outwards from the ball channel and then guided inside or outside the spindle nut in a channel, a tube, or a bore before being fed back into the ball channel between the threaded spindle and the spindle nut (external deflection). However, there are also so-called internal deflections, in which the ball deflection leads radially inward into the threaded spindle.

### DESCRIPTION OF THE PRIOR ART

DE 198 57 581 A1 shows a ball screw drive with internal deflection, in which the deflection of the balls into a return channel is achieved by means of deflection pieces that describe a wide quarter circle and then guide the balls into the return channel in a tight curve.

US 2015/369349 A1 describes a two-part ball screw drive with internal deflection into the threaded spindle. The path of the ball in the ball deflection initially describes a semicircle between the ball channel and the lowest point of the deflection channel, which is located in the central axis of the threaded spindle. A comparatively short, level deflection guides the balls into the deflection channel arranged in the central axis of the threaded spindle.

Document WO 2015/081 131 A1 shows a ball screw drive with internal deflection and a deflection channel located in the central axis. The balls are guided directly to the level of the deflection channel by a radial shaft. Lifting and deflection are ensured by a pipe section inserted into the shaft, which has shovel-shaped tongues that deflect the balls accordingly.

### SUMMARY

When a ball screw drive is under load during operation, the balls in the ball channel are primarily subject to compressive stresses. These must be relieved in the ball deflection before the balls can be guided into the deflection channel without load. The return to the ball channel must perform the same function in reverse order. The task is therefore to define a ball deflection that can ensure ball relief and deflection into the deflection channel (or vice versa) as precisely as possible. The ball deflections should also be simple in design and inexpensive to manufacture.

The present invention is therefore based on a generic ball screw drive (BSD) with internal deflection. Such a ball screw drive comprises a threaded spindle and a spindle nut that at least partially surrounds the threaded spindle coaxially, i.e., the sleeve-shaped spindle nut can be shorter than the spindle nut in relation to the center axis of the ball screw drive. During operation, a large number of balls circulate in a helical (spiral) ball channel in the space between the threaded spindle and the spindle nut. In order to ensure a closed circulation path for these balls, at least one ball return system with two ball deflections and an intermediate deflection channel is provided in the threaded spindle. These ball deflections can be inserted into appropriately designed openings in the threaded spindle so that they can guide the circulating balls from the ball channel into the deflection channel or out of it. These openings can preferably be shaped like ovals or elongated holes, which can be easily produced by milling. The deflection channel is designed as a borehole parallel to the longitudinal axis in the threaded spindle. However, the channel can also be produced using equivalent methods.

The following section examines the guide path of the balls. This term refers to the target path of the balls during operation of the ball screw drive, which is essentially determined by the mechanical or structural limitations in the ball groove, the ball channel, the ball deflection, and the deflection channel. In the attached drawings, this guide path is idealized by a line formed by the position of the centers of gravity of the balls in the circulation of the ball screw drive. The fact that the actual path may deviate from the guide path as a result of wear, (necessary) play, or depending on the mode of operation does not detract from the inventive concept.

It should be noted that the technical implementation of a ball deflection as a component to be inserted into the threaded spindle does not necessarily mean that the technical component of the ball deflection itself encloses the guide path on all sides. As shown in the drawings, it can also be implemented as a component that only fulfills the guide function for the balls after being inserted into the recess in the threaded spindle. In other words, wall areas of the recess can supplement the ball deflection so that together they enclose the guide path. This does not detract from the invention, because the guide path is still clearly visible to the person skilled in the art on the ball deflection. In such a preferred embodiment, the guide path for the balls is enclosed in a tubular manner within a ball deflection (inserted into the threaded spindle). The wall of the tube is composed of sections of surface areas of the openings in the threaded spindle and the ball deflection itself. The term “tubular” is not to be interpreted as meaning that the entire guide path is enclosed by a perfect tube. As will be understood by those skilled in the art, the tube is designed in such a way that the steering and guide function for the balls is optimally fulfilled in terms of safety and noise generation.

However, the guide path for the balls from the ball channel into the deflection channel, i.e., in the ball deflection mechanism, will always ensure at least one circular passage with a clear width L_{W}. This is chosen to be slightly larger than the diameter of the circulating balls, usually a few tenths of a millimeter larger.

The ball deflection comprises at least two deflection sections. A deflection section is an area or section of the guide path that has a uniform curvature. A mathematically exact semicircle, for example, has a curvature of 180°, a quarter circle a curvature of 90°. “Uniform” curvature does not mean that a deflection section must have a uniform radius of curvature. The guide path in the deflection section can also follow the curve shape of an ellipse or other mathematical curve. When referring to a deflection section with a quarter circle, the beginning and end of the deflection section have identical circular passages whose (extended) planes intersect at right angles.

Consequently, an identifiable (distinguishable) change of direction occurs between two deflection sections because an existing curvature ends. In the present invention, the second of at least two deflection sections is considered, which is immediately adjacent to the transition to the spherical channel. It is derived from the basic shape of a quarter circle in such a way that the (actual) transition from the ball deflection to the subsequent deflection channel is set back parallel to the end plane of the ideal quarter circle by a distance d₁ and, at the same time, the passage L_{W} is extended in height by a distance d₂. As can be seen in the figures, the introduction from the ball deflection into the deflection channel is therefore no longer perfectly tangential, but discontinuous.

The extension d₂ is usually made on the section of the ball deflection that points away from the center axis of the ball screw drive. Preferably, d₁≈d₂ applies, in other words, the offset is essentially chosen to be the same size. Depending on the design of the ball deflection, a specialist will be able to implement this specification without further ado.

Preferably, the ball deflection(s) are designed as a single piece. They can be manufactured as plastic injection molded parts, die-cast metal parts, or metal injection molded parts. Injection molding, even in metal, allows for geometries that cannot be achieved with conventional machining processes or as sheet metal bent parts.

Furthermore, it is preferable to set the two offsets d₁ and d₂ such that: 0.2 mm≤d₁≤0.3 mm and 0.15 mm ≤d₂≤0.25 mm.

For smooth operation, it has been shown that the clear width Lw in the ball deflection should be selected 0.2 mm to 0.4 mm larger than the diameter of the balls provided in the ball screw drive. A realistic embodiment of a ball screw drive uses balls with a nominal diameter of 3.6 mm in operation with a clear width Lw between 3.8 mm and 4 mm (both values included).

One embodiment of a ball screw drive provides that d1≥d2.

### BRIEF DESCRIPTION OF THE DRAWINGS

FIG. 1 shows a cross-sectional view of a generic ball screw drive with internal deflection according to the prior art.

FIG. 2 shows a schematic diagram of various terms and technical features that are important for the invention.

FIG. 3 shows a top view of a ball deflection device designed as a semi-open shell that can be inserted into a threaded spindle.

FIG. 4 is an oblique view of the component from FIG. 3.

FIG. 5 is a side view of an inventively designed ball deflection with the transition to the deflection channel.

### DETAILED DESCRIPTION

The invention is explained below by way of example with reference to the accompanying drawings.

FIG. 1 shows a ball screw drive 100 with an internal deflection according to the prior art and is intended to explain the terms used. The threaded spindle 110 has a helically wound ball groove 140 on its cylindrical outer surface, which is shell-shaped in cross-section. A spindle nut 120 has a complementarily shaped ball groove on its hollow cylindrical inner surface. Together, these grooves form a ball channel 130 in which balls 150 can circulate during operation. In order to achieve a closed circulation path for the balls 150, the ball screw drive 100 has at least one ball return system 160 (depending on the design), which comprises two ball deflections 170, 170′ and a deflection channel 180. This deflection channel 180 is designed as a bore 200 parallel to the center axis 190 of the threaded spindle 110. The ball deflections guide the balls from the ball channel 130 into the deflection channel and back again. The ball deflections are usually designed to be identical or mirror-symmetrical so that the rotational behavior of the ball screw drive 100 is independent of the direction of drive.

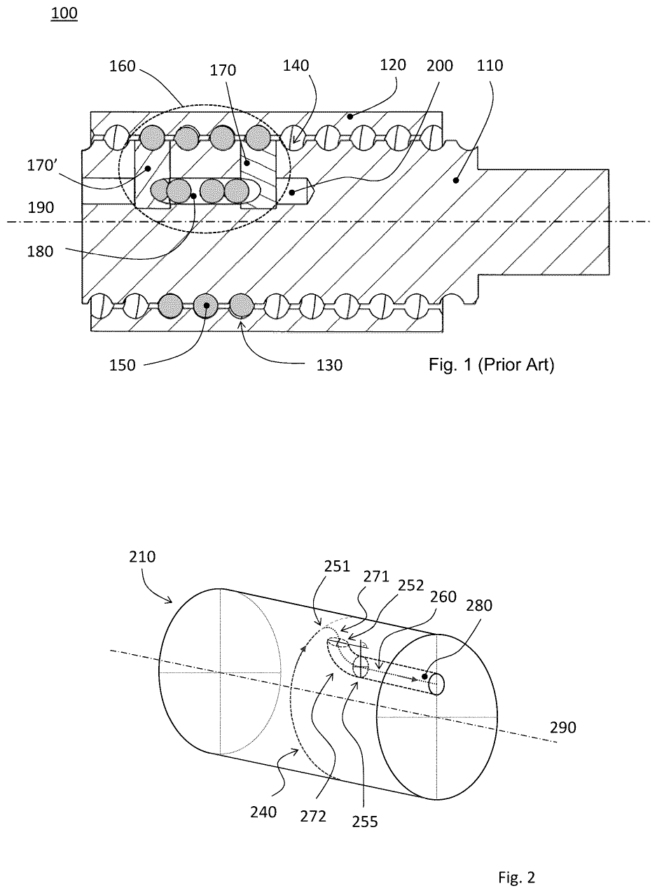

FIG. 2 shows an abstract representation of the elements and terms relevant to understanding the invention from the circulation path of a ball (not shown) from a ball channel into a deflection channel 280. A threaded spindle 210 is shown as a cylinder with a single ball groove 240 indicated as a dashed line. At a point designated 251, the diversion from the ball groove 240 into a first deflection section 271 begins. The path of the ball through the ball return system is indicated by a thin dotted line, the guide path 260, which-virtually-marks the path of the center point of a ball. The transition 252 between the first and second deflection sections (271-272) is indicated by a circular surface; the passage of the guide path 260 is marked by a center cross. At reference sign 255, the deflection channel 280 begins, which is arranged parallel to the center axis 290. The second deflection section 272 is important for the present invention, which is why it is described in greater detail than the first deflection section 271, which merely describes the section from the ball groove 240 to the beginning of the second deflection section 272/transition 252.

The second deflection section 272 classically (not according to the invention) describes a quarter circle that runs cleanly tangentially into the deflection channel 280. In this figure, the plane of the transition 252 is shown such that a normal line runs exactly radially through the center cross of the transition 252 and thus forms a perpendicular line from the center axis 290 to the surface of the threaded spindle 210. However, this is not mandatory. The quarter circle of the first deflection section could also be inclined toward the outlet 251, with the circular area of the end of the quarter circle 255 remaining stationary. Nevertheless, the planes of the circular areas of transition 252 and the end of the quarter circle 255 would still intersect at 90°.

The circular surfaces of “transition 252” and “end of quarter circle 254” mentioned above are not arbitrary or virtual, but refer to cross-sections of the guide path that correspond to at least one ball diameter plus the corresponding tolerance dimension. For reasons of clarity, only one ball deflection is shown in FIG. 2; the corresponding counterpart would be designed according to the same logic.

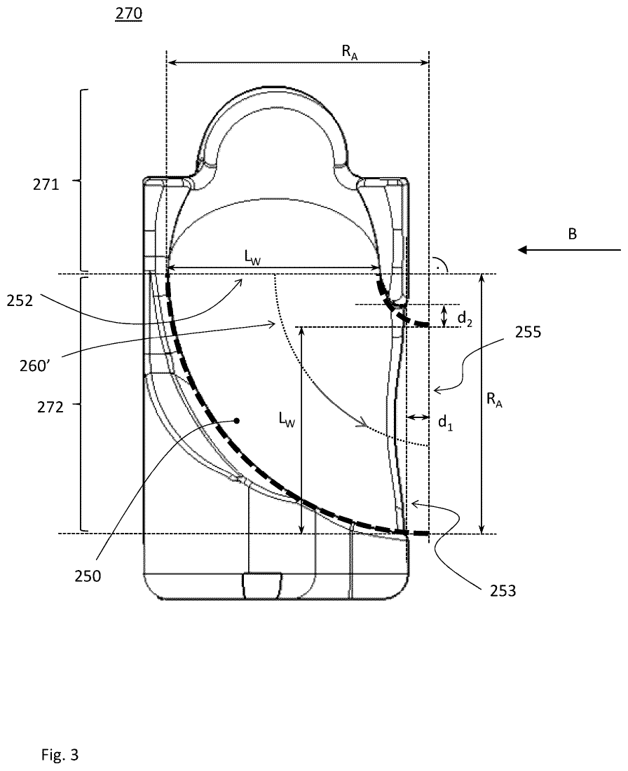

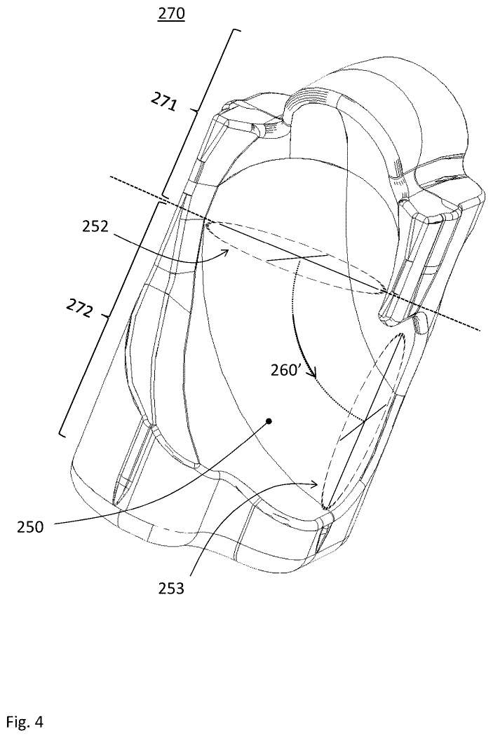

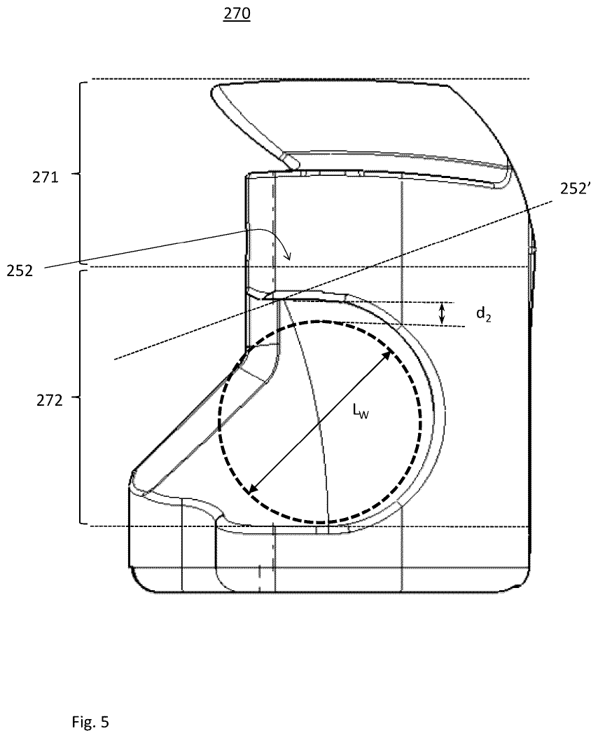

FIG. 3 shows a ball deflection 270 according to the invention with a first deflection section 271 and a second deflection section 272. The cross-section is positioned so that the quarter circle 250 of the second deflection section is intersected exactly along the guide path 260′. The planes of the end 255 and the transition 252 are perpendicular to each other. Both at the transition 252 and at the end of the quarter circle 255, a circular passage width with the dimension L_{W} is ensured (better visible in FIG. 4). R_{A} describes the radius of the quarter circle 250. This figure clearly shows that although the ball deflection 270 accommodates the quarter circle 250, the ball path 260′ is shortened because the outlet of the quarter circle 250 is incomplete. The plane of the end 255 of the quarter circle 250 is offset in a plane-parallel manner by a distance d₁, so that the transition into the deflection channel or the end of the ball deflection 253 is no longer tangential. Since the offset of the end plane is plane-parallel and the quarter circle is therefore not shortened by a specific angle, the end opening of the ball deflection, marked by reference 253, is simultaneously widened by a distance d₂. Even in this plane of reference 253, where the ball deflection effectively opens into the deflection channel 280 (not shown), at least the clear diameter L_{W} is guaranteed. The letter B indicates the viewing direction of FIG. 5 onto the ball deflection 270.

FIG. 4 is an oblique view of the ball deflection 270 as shown in FIG. 3. The second deflection section 272 begins at the transition 252 and allows a guide path 260′ along a quarter circle that ends at the reference 253 at the end of the ball deflection. The planes of transition 252 and end of ball deflection 253 are perpendicular to each other because, as described above, the rear offset of the end plane 255 (not shown again here) of the outgoing quarter circle 250 is parallel to the plane of reference 253. The circular areas at transition 252 and end of ball deflection 253 have the clear diameter L_{W}.

FIG. 5 is a view of a ball deflection 270 from viewing direction B as shown in FIG. 3. The transition plane 252 is drawn here parallel to the lower edge of the ball deflection 270. However, as explained above, this is not mandatory. The plane could also be tilted, as drawn as 252′, without thus changing the inventive teaching.

1. A ball screw drive (100) comprising
a threaded spindle (110, 210) and a spindle nut (120, 210) that at least partially surrounds the threaded spindle (110, 210) coaxially;
a plurality of balls (150) that are adapted to circulate in a helical ball channel (130) in a space between the threaded spindle and the spindle nut;
at least one ball return system (160) consisting of two ball deflections (170, 170′, 270) with a deflection channel (180, 280) located therebetween;
wherein the ball deflections (170, 170′, 270) are adapted to be inserted into openings in the threaded spindle (110, 210) such that they are adapted to guide the balls (150) out from the ball channel (130) into the deflection channel (180, 280) or from the deflection channel (180, 280) back into the ball channel (130);
wherein the deflection channel (180, 280) is formed as a bore (200) in the threaded spindle (110) parallel to a longitudinal axis, thereby establishing a closed deflection path for the balls (150) in the ball screw drive (100);
wherein the guide path (260′) for ball(s) (150) from the ball channel into the deflection channel (280)
always has at least one circular passage with a clear width (L_{W}), and
comprises at least first and second deflection sections (271, 272) with distinguishable curvatures, wherein the second deflection section (272), which is directly adjacent to a transition to the ball channel (280), is derived from a basic shape of a quarter circle (250); and
the transition (252) from the ball deflection (270) to the deflection channel (280) is set back by a first distance d₁ parallel to an end plane (254) of an ideal of the basic shape of the quarter circle (250) and the passage is extended in height by a second distance d₂, where d₁≈d₂.

2. The ball screw drive (100) according to claim 1, wherein each of the ball deflections (210) is formed as a single piece.

3. The ball screw drive (100) according to claim 1, wherein 0.2 mm≤d₁≤0.3 mm and 0.15 mm≤d₂≤0.25 mm.

4. The ball screw drive (100) according to claim 1, wherein the ball deflection (210) comprises a plastic injection molded part, a die-cast metal part, or a metal injection molded part.

5. The ball screw drive (100) according to claim 1, wherein the guide path (260, 260′) is enclosed in a tubular manner within the ball deflection (170, 170′), and a wall of the tube is formed in sections of surface areas of the openings in the threaded spindle (110, 210) and the ball deflection (170, 170′).

6. The ball screw drive (100) according to claim 1, wherein the clear width (Lw) is selected to be 0.2 mm to 0.4 mm larger than a diameter of the balls (150) in the ball screw drive.

7. The ball screw drive (100) according to claim 1, wherein the balls have a diameter of 3.6 mm and the clear width (Lw) is greater than or equal to 3.8 mm and less than or equal to 4 mm.

8. The ball screw drive (100) according to claim 1, wherein d₁≥d₂.
